(19) United States
(12) Patent Application Publication
(10) Pub. No.: US 2026/0116823 A1
(43) Pub. Date: Apr. 30, 2026

(54) FULL SOLID-WASTE MICRO-EXPANSIVE CONCRETE AND PREPARATION METHOD THEREOF

(71) Applicant: Inner Mongolia University of Technology, Hohhot (CN)

(72) Inventors: Changwang YAN, Hohhot (CN); Rongrong FENG, Hohhot (CN); Ju ZHANG, Hohhot (CN); Ru BAI, Hohhot (CN); Xiaoxiao WANG, Hohhot (CN)

(21) Appl. No.: 19/354,924

(22) Filed: Oct. 10, 2025

(30) Foreign Application Priority Data
Oct. 30, 2024 (CN) 2024115309914

(51) Int. Cl. C04B 28/14; B01D 15/36; C04B 11/024; C04B 11/26; C04B 18/165; C04B 20/02; C04B 24/26; C04B 111/00; C04B 111/34

(52) U.S. Cl. CPC C04B 28/144; B01D 15/363; C04B 11/024; C04B 11/264; C04B 18/165; C04B 20/026; C04B 24/2623; C04B 2111/00767; C04B 2111/34

(57) ABSTRACT

A full solid-waste micro-expansive concrete and its preparation method are provided, and relate to the field of concrete material technologies. The full solid-waste micro-expansive concrete includes the following components in parts by weight: 920-1060 parts of a coarse aggregate, 460-582 parts of a fine aggregate, 11-19 parts of an expansive agent, 389-512 parts of a modified solid-waste-based cementitious material, and 231-268 parts of water. The coarse aggregate is coal gangue. The fine aggregate is waste ceramic. The modified solid-waste-based cementitious material includes a solid-waste-based clinker, modified polyvinyl alcohol, and a modified anion exchange resin. The solid-waste-based clinker is prepared from the coal gangue, carbide slag, and desulfurization gypsum. The expansive agent is obtained by calcining the carbide slag. The concrete prepared can ensure the initial strength of the concrete, and guarantee continuous micro-expansion in the later stage, compensating for shrinkage and thereby increasing the overall strength of the concrete.

### CROSS-REFERENCE TO RELATED APPLICATION

This application claims priority to Chinese Patent Application No. 202411530991.4, filed Oct. 30, 2024, which is herein incorporated by reference in its entirety.

### TECHNICAL FIELD

The disclosure relates to the field of concrete material technologies, and more particularly to a full solid-waste micro-expansive concrete and its preparation method.

### BACKGROUND

In China, the stockpile of solid wastes is large, the utilization rate of the solid wastes is low, and there are significant environmental and ecological safety hazards. The utilization of the solid wastes in building materials is one of the main ways to solve the current situation of waste accumulation. Therefore, the resource utilization rate of solid wastes can be improved by using the solid wastes to prepare a coarse aggregate, a fine aggregate, cement, and other materials and applying them in concrete to prepare full solid-waste concrete. This is of great significance for conserving resources and promoting the green and high-quality development of the concrete industry.

During the hardening and use of concrete, volume shrinkage occurs. Excessive shrinkage can lead to structural cracking, thereby affecting its performance. When formulating concrete, adding a certain amount of expansive agent can cause the concrete to expand in volume during hardening, offsetting the shrinkage and thus preventing structural cracking. At present, the expansive agent used in the application of solid waste materials in concrete is generally a calcium oxide (CaO) expansive agent or a calcium sulphoaluminate expansive agent. These expansive agents can all be directly processed from the solid wastes. However, whether it is the CaO expansive agent or the calcium sulphoaluminate expansive agent, the hydration rate thereof is relatively fast. A large amount of expansion energy is consumed during the plastic stage of the concrete. The rapid hydration expansion has a smaller compensatory effect on the shrinkage of concrete in middle and later stages, leading to a decrease in the overall strength of the concrete.

To address the problems raised in the above background technology, a full solid-waste micro-expansive concrete and its preparation method is proposed.

### SUMMARY

The disclosure aims to provide a full solid-waste micro-expansive concrete and its preparation method to address the above problems in the related art.

In order to achieve the above purposes, the disclosure provides the following technical solutions.

A full solid-waste micro-expansive concrete includes the following components in parts by weight: 920-1060 parts of a coarse aggregate, 460-582 parts of a fine aggregate, 11-19 parts of an expansive agent, 389-512 parts of a modified solid-waste-based cementitious material, and 231-268 parts of water. The coarse aggregate is coal gangue; the fine aggregate is waste ceramic; the modified solid-waste-based cementitious material includes a solid-waste-based clinker, modified polyvinyl alcohol, and a modified anion exchange resin; the solid-waste-based clinker is prepared from the coal gangue, carbide slag, and desulfurization gypsum; and the expansive agent is obtained by calcining the carbide slag.

The modified solid-waste-based cementitious material is prepared through the following steps:
S101, dissolving polyvinyl alcohol in water at 90 degrees Celsius (° C.) to obtain a polyvinyl alcohol solution, adding powder of calcium hydroxide to the polyvinyl alcohol solution, and then stirring and mixing for 8-12 hours (h), followed by drying at a low temperature in a range of 50-65° C. for solvent removement to obtain the modified polyvinyl alcohol;
S102, washing an anion exchange resin with acid and alkali sequentially to obtain a washed anion exchange resin, placing the washed anion exchange resin into an exchange column, and performing exchange with a sulfate solution, followed by washing with water and drying to obtain the modified anion exchange resin;
S103, mixing the solid-waste-based clinker with the modified anion exchange resin uniformly, and then grinding the solid-waste-based clinker and the modified anion exchange resin followed by sieving through a 200-mesh screen to obtain a mixture; and
   S104, dissolving the modified polyvinyl alcohol obtained in step S101 in a mixed solvent of petroleum ether and toluene to obtain a mixed solution, and adding the mixture obtained in step S103 to the mixed solution, followed by stirring for 3-5 h and drying at a low temperature in a range of 50-65° C. to remove the petroleum ether and the toluene to obtain the modified solid-waste-based cementitious material.

In an embodiment, in step S101, a weight ratio of the calcium hydroxide to the polyvinyl alcohol to the water is in a range of 1:(5-8):(22-36).

In an embodiment, in step S102, the acid is a hydrochloric acid solution, time for washing the anion exchange resin with the acid is in a range of 2-4 h, a concentration of the hydrochloric acid solution is 3 moles per liter (mol/L), and a weight ratio of the hydrochloric acid solution to the anion exchange resin is 5:1; the alkali is a sodium hydroxide solution, time for washing the anion exchange resin with the alkali is in a range of 1-4 h, a concentration of the sodium hydroxide solution is 2 mol/L, and a weight ratio of the sodium hydroxide solution to the anion exchange resin is 5:1; and the sulfate solution is a sodium sulfate solution, a concentration of the sodium sulfate solution is 0.4 mol/L, and a weight ratio of the sodium sulfate solution to the anion exchange resin is 1:4.

In an embodiment, in step S104, a weight ratio of the petroleum ether to the toluene is 1:1, and a weight ratio of the modified anion exchange resin to the modified polyvinyl alcohol to the solid-waste-based clinker to the petroleum ether is in a range of 1:(0.8-1.8):(8-20):(45-60).

In an embodiment, the solid-waste-based clinker is prepared through the following steps:
S201, washing and air-drying the coal gangue, the carbide slag and the desulfurization gypsum to obtain dried materials, crushing the dried materials in a crusher to obtain crushed materials, grinding the crushed materials in a ball mill to obtain ground materials, and placing the ground materials in an oven for drying at 105° C. until constant weight followed by sieving through a 50-mesh screen to obtain sieved materials;
S202, mixing thoroughly the sieved materials obtained in step S201 in a weight ratio of the coal gangue to the carbide slag to the desulfurization gypsum being 3:5:2 in a mixer, followed by adding water and stirring uniformly to obtain a solid-waste-based raw material; and
S203, pressing the solid-waste-based raw material in a steel mold into a test pat, drying the test pat in a blast drying oven at 105° C. for 3 h to obtain a dried test pat, performing multi-stage calcining on the dried test pat in a high-temperature box furnace followed by cooling to room temperature to obtain a cooled test pat, crushing the cooled test pat into small pieces, and grinding the small pieces in a grinder followed by sieving through the 50-mesh screen to obtain the solid-waste-based clinker.

In an embodiment, in step S202, a weight ratio of the water to a total of the coal gangue, the carbide slag and the desulfurization gypsum is 1:2.5.

In an embodiment, in step S203, the multi-stage calcining includes: a first stage from the room temperature to 950° C. with a heating rate of 10° C. per minute (° C./min), a second stage from 950° C. to 1290° C. with a heating rate of 5° C./min, and a third stage at 1290° C. for 45 min.

In an embodiment, the expansive agent is obtained by calcining the carbide slag at 900° C.

A preparation method of the full solid-waste micro-expansive concrete includes the following steps:
S1, washing and air-drying the coarse aggregate to obtain a dried coarse aggregate, and crushing the dried coarse aggregate in a crusher followed by sieving to obtain a sieved coarse aggregate with a particle size in a range of 5-20 millimeters (mm);
S2, washing and air-drying the fine aggregate to obtain a dried fine aggregate, crushing the dried fine aggregate in a crusher to obtain a crushed fine aggregate, grinding the crushed fine aggregate in a grinder followed by sieving to obtain a sieved fine aggregate with a particle size in a range of 1-5 mm; and
S3, mixing and stirring uniformly the sieved coarse aggregate, the sieved fine aggregate, the modified solid-waste-based cementitious material, and the water to obtain the full solid-waste micro-expansive concrete.

Compared to the related art, the disclosure has the following beneficial effects.

1. The disclosure uses solid wastes such as the coal gangue, the carbide slag, the desulfurization gypsum, and the waste ceramic to prepare the full solid-waste concrete, which can massively consume the solid wastes and reduce environmental pollution. The CaO-based expansive agent prepared from the carbide slag provides expansion for the initial hardening of the concrete, thereby increasing the initial hardening strength of the concrete.

The modified solid-waste-based cementitious material in the disclosure contains the modified polyvinyl alcohol and the modified ion exchange resin. The polyvinyl alcohol and the anion exchange resin can relatively encapsulate the surface of the calcium sulphoaluminate, effectively reducing the initial hydration rate of the calcium sulphoaluminate. Moreover, the modified polyvinyl alcohol and the modified ion exchange resin can slowly release calcium ions (Ca²⁺) and sulfate ions (SO₄²⁻). During the hydration of the calcium sulphoaluminate, these ions combine with the hydration products, increasing the strength of the hydration products. The concrete achieves continuous micro-expansion, compensating for the later internal shrinkage of the concrete, thereby obtaining higher strength.

### BRIEF DESCRIPTION OF DRAWINGS

FIG. 1 illustrates a process flowchart diagram of preparing a modified solid-waste-based cementitious material according to the disclosure.

FIG. 2 illustrates a process flowchart diagram of preparing a solid-waste-based clinker according to the disclosure.

### DETAILED DESCRIPTION OF EMBODIMENTS

The technical solutions in embodiments of the disclosure will be clearly and completely described below in conjunction with the accompanying drawings. Apparently, the described embodiments are only a part of the embodiments of the disclosure, not all of them. Based on the embodiments of the disclosure, all other embodiments obtained by those skilled in the art without creative labor are within the scope of protection of the disclosure.

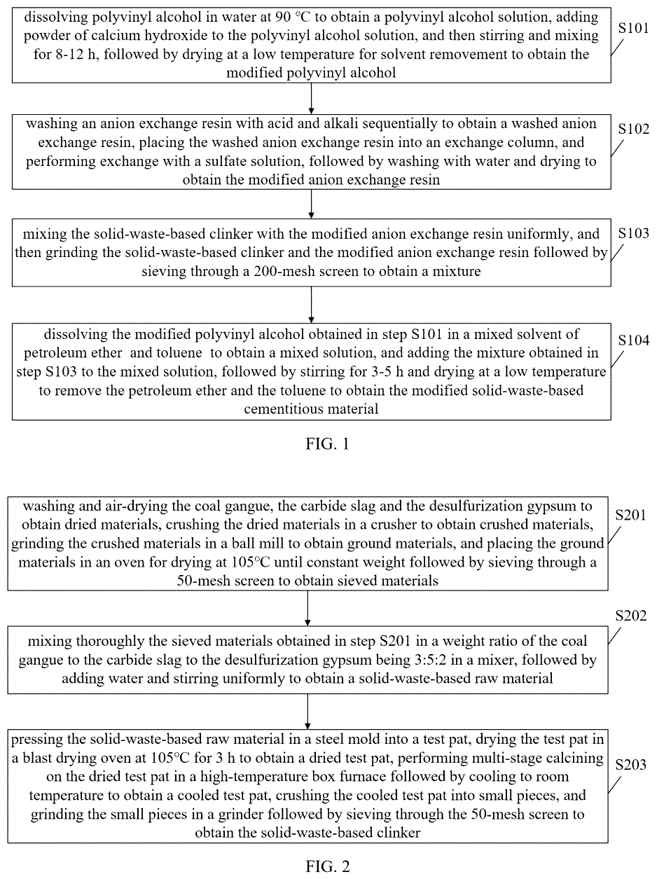

Referring to FIGS. 1-2, the disclosure provides a full solid-waste micro-expansive concrete and its preparation method. Coal gangue is used as a coarse aggregate. The coal gangue after washing and air-drying is crushed to obtain the coarse aggregate with a particle size in a range of 5-20 mm. Waste ceramic is a fine aggregate. The waste ceramic after washing and air-drying is crushed to obtain the fine aggregate with a particle size in a range of 1-5 mm. An expansive agent is carbide slag calcined at 900° C. A modified solid-waste-based cementitious material includes a solid-waste-based clinker, modified polyvinyl alcohol, and a modified anion exchange resin. The solid-waste-based clinker is prepared from the coal gangue, the carbide slag, and desulfurization gypsum.

The chemical composition of the coal gangue is as follows: 33.74% of silicon dioxide (SiO₂), 31.67% of aluminum oxide (Al₂O₃), 1.81% of CaO, 1.59% of sulfur trioxide (SO₃), 1.21% of titanium dioxide (TiO₂), 0.74% of ferric oxide (Fe₂O₃), 0.64% of magnesium oxide (MgO), and 28.6% of other oxides.

The chemical composition of the carbide slag is as follows: 7.62% of SiO₂, 0.33% of Al₂O₃, 67.26% of CaO, 1.09% of SO₃, 0.09% of TiO₂, 1.24% of sodium oxide (Na₂O), and 22.37% of other oxides.

The chemical composition of the desulfurization gypsum is as follows: 7.21% of SiO₂, 0.31% of Al₂O₃, 25.62% of CaO, 47.62% of SO₃, 3.91% of Na₂O, and 15.33% of other oxides.

The anion exchange resin is a strongly basic styrene-based anion exchange resin, with a specifically model number of 201×7 (717). The polyvinyl alcohol has a model type of 17-88.

In the disclosure, the carbide slag is subjected to high-temperature calcination to form the expansive agent primarily composed of CaO. The CaO hydrates rapidly, providing expansion for the initial hardening of the concrete.

This disclosure further includes a modified solid-waste-based cementitious material prepared based on the solid-waste-based clinker. The solid-waste-based clinker is prepared by high-temperature calcination of a solid-waste-based raw material. CaO, Al₂O₃, and calcium sulfate in the solid-waste-based raw material undergo chemical reactions to form the calcium sulphoaluminate. Therefore, the modified solid-waste-based cementitious material in the disclosure is based on the calcium sulphoaluminate, and simultaneously compounded with modified polyvinyl alcohol and the modified anion exchange resin through modification, which can control the hydration rate of the calcium sulphoaluminate. Moreover, the material can slowly release Ca²⁺ and SO₄²⁻. During the hydration of the calcium sulphoaluminate, these ions combine with the hydration products, increasing the strength of the hydration products. The cementitious material achieves continuous micro-expansion in concrete, compensating for the later internal shrinkage of the concrete, thereby obtaining higher strength.

Specifically, the disclosure provides the following embodiments as the composition of the components of the full solid-waste micro-expansive concrete of the disclosure.

### Embodiment 1

A full solid-waste micro-expansive concrete includes the following components in parts by weight: 1006 grams (g) of the coarse aggregate, 516 g of the fine aggregate, 14 g of the expansive agent, 481 g of the modified solid-waste-based cementitious material, and 237 g of water. Raw materials of the components are mixed uniformly through a mixer to obtain the full solid-waste micro-expansive concrete.

The modified solid-waste-based cementitious material is prepared through the following steps S101-S104.

S101, 60 g of polyvinyl alcohol is dissolved in 280 g of water at 90° C. to obtain a polyvinyl alcohol solution, and 10 g of powder of calcium hydroxide is added to the polyvinyl alcohol solution, and then stirred and mixed for 9 h, followed by drying at a low temperature for solvent removement to obtain the modified polyvinyl alcohol.

S102, 50 g of an anion exchange resin is acid-washed with 250 g of a hydrochloric acid solution at 3 mol/L for 3.5 h followed by removing the acid solution to obtain an acid-washed anion exchange resin; the acid-washed anion exchange resin is placed in 250 g of a sodium hydroxide solution at 2 mol/L for alkaline washing for 2.6 h, followed by removing the sodium hydroxide solution to obtain a washed anion exchange resin; and the washed anion exchange resin is placed into an exchange column, and is subjected to exchange with 12.5 g of a sodium sulfate solution at 0.4 mol/L, followed by washing with water and drying to obtain the modified anion exchange resin.

S103, 516 g of the solid-waste-based clinker is mixed uniformly with 43 g of the modified anion exchange resin, and then the solid-waste-based clinker and the modified anion exchange resin are ground followed by sieving through a 200-mesh screen to obtain a mixture.

S104, 51 g of the modified polyvinyl alcohol obtained in step S101 is dissolved in a mixed solvent of 2200 g of petroleum ether and 2200 g of toluene to obtain a mixed solution, and the mixture obtained in step S103 is added to the mixed solution, followed by stirring for 4.2 h and drying at a low temperature to remove the petroleum ether and the toluene to obtain the modified solid-waste-based cementitious material.

### Embodiment 2

A full solid-waste micro-expansive concrete includes the following components in parts by weight: 920 g of the coarse aggregate, 460 g of the fine aggregate, 11 g of the expansive agent, 389 g of the modified solid-waste-based cementitious material, and 231 g of water. Raw materials of the components are mixed uniformly through a mixer to obtain the full solid-waste micro-expansive concrete.

The modified solid-waste-based cementitious material is prepared through the following steps S101-S104.

S101, 50 g of polyvinyl alcohol is dissolved in 220 g of water at 90° C. to obtain a polyvinyl alcohol solution, and 10 g of powder of calcium hydroxide is added to the polyvinyl alcohol solution, and then stirred and mixed for 8 h, followed by drying at a low temperature for solvent removement to obtain the modified polyvinyl alcohol.

S102, 70 g of an anion exchange resin is acid-washed with 350 g of a hydrochloric acid solution at 3 mol/L for 2 h followed by removing the acid solution to obtain an acid-washed anion exchange resin; the acid-washed anion exchange resin is placed in 350 g of a sodium hydroxide solution at 2 mol/L for alkaline washing for 1 h, followed by removing the sodium hydroxide solution to obtain a washed anion exchange resin; and the washed anion exchange resin is placed into an exchange column, and is subjected to exchange with 17.5 g of a sodium sulfate solution at 0.4 mol/L, followed by washing with water and drying to obtain the modified anion exchange resin.

S103, 484 g of the solid-waste-based clinker is mixed uniformly with 61 g of the modified anion exchange resin, and then the solid-waste-based clinker and the modified anion exchange resin are ground followed by sieving through a 200-mesh screen to obtain a mixture.

S104, 49 g of the modified polyvinyl alcohol obtained in step S101 is dissolved in a mixed solvent of 2205 g of petroleum ether and 2205 g of toluene to obtain a mixed solution, and the mixture obtained in step S103 is added to the mixed solution, followed by stirring for 3 h and drying at a low temperature to remove the petroleum ether and the toluene to obtain the modified solid-waste-based cementitious material.

### Embodiment 3

A full solid-waste micro-expansive concrete includes the following components in parts by weight: 1060 g of the coarse aggregate, 582 g of the fine aggregate, 19 g of the expansive agent, 512 g of the modified solid-waste-based cementitious material, and 268 g of water. Raw materials of the components are mixed uniformly through a mixer to obtain the full solid-waste micro-expansive concrete.

The modified solid-waste-based cementitious material is prepared through the following steps S101-S104.

S101, 56 g of polyvinyl alcohol is dissolved in 252 g of water at 90° C. to obtain a polyvinyl alcohol solution, and 7 g of powder of calcium hydroxide is added to the polyvinyl alcohol solution, and then stirred and mixed for 12 h, followed by drying at a low temperature for solvent removement to obtain the modified polyvinyl alcohol.

S102, 30 g of an anion exchange resin is acid-washed with 150 g of a hydrochloric acid solution at 3 mol/L for 4 h followed by removing the acid solution to obtain an acid-washed anion exchange resin; the acid-washed anion exchange resin is placed in 150 g of a sodium hydroxide solution at 2 mol/L for alkaline washing for 4 h, followed by removing the sodium hydroxide solution to obtain a washed anion exchange resin; and the washed anion exchange resin is placed into an exchange column, and is subjected to exchange with 7.5 g of a sodium sulfate solution at 0.4 mol/L, followed by washing with water and drying to obtain the modified anion exchange resin.

S103, 564 g of the solid-waste-based clinker is mixed uniformly with 28.2 g of the modified anion exchange resin, and then the solid-waste-based clinker and the modified anion exchange resin are ground followed by sieving through a 200-mesh screen to obtain a mixture.

S104, 50.8 g of the modified polyvinyl alcohol obtained in step S101 is dissolved in a mixed solvent of 1692 g of petroleum ether and 1692 g of toluene to obtain a mixed solution, and the mixture obtained in step S103 is added to the mixed solution, followed by stirring for 5 h and drying at a low temperature to remove the petroleum ether and the toluene to obtain the modified solid-waste-based cementitious material.

### Embodiment 4

A full solid-waste micro-expansive concrete includes the following components in parts by weight: 985 g of the coarse aggregate, 532 g of the fine aggregate, 16 g of the expansive agent, 496 g of the modified solid-waste-based cementitious material, and 251 g of water. Raw materials of the components are mixed uniformly through a mixer to obtain the full solid-waste micro-expansive concrete.

The modified solid-waste-based cementitious material is prepared through the following steps S101-S104.

S101, 48 g of polyvinyl alcohol is dissolved in 190 g of water at 90° C. to obtain a polyvinyl alcohol solution, and 6 g of powder of calcium hydroxide is added to the polyvinyl alcohol solution, and then stirred and mixed for 10.6 h, followed by drying at a low temperature for solvent removement to obtain the modified polyvinyl alcohol.

S102, 36 g of an anion exchange resin is acid-washed with 180 g of a hydrochloric acid solution at 3 mol/L for 2.5 h followed by removing the acid solution to obtain an acid-washed anion exchange resin; the acid-washed anion exchange resin is placed in 180 g of a sodium hydroxide solution at 2 mol/L for alkaline washing for 1.5 h, followed by removing the sodium hydroxide solution to obtain a washed anion exchange resin; and the washed anion exchange resin is placed into an exchange column, and is subjected to exchange with 9 g of a sodium sulfate solution at 0.4 mol/L, followed by washing with water and drying to obtain the modified anion exchange resin.

S103, 520 g of the solid-waste-based clinker is mixed uniformly with 32.5 g of the modified anion exchange resin, and then the solid-waste-based clinker and the modified anion exchange resin are ground followed by sieving through a 200-mesh screen to obtain a mixture.

S104, 46 g of the modified polyvinyl alcohol obtained in step S101 is dissolved in a mixed solvent of 1600 g of petroleum ether and 1600 g of toluene to obtain a mixed solution, and the mixture obtained in step S103 is added to the mixed solution, followed by stirring for 4.6 h and drying at a low temperature to remove the petroleum ether and the toluene to obtain the modified solid-waste-based cementitious material.

The solid-waste-based clinker in the above embodiments are prepared through the following steps S201-S203.

S201, 3000 g of the coal gangue, 5000 g of the carbide slag and 2000 g of the desulfurization gypsum are washed and air-dried to obtain dried materials, the dried materials are crushed in a crusher to obtain crushed materials, the crushed materials are ground in a ball mill to obtain ground materials, and the ground materials are placed in an oven for drying at 105° C. until constant weight followed by sieving through a 50-mesh screen to obtain sieved materials.

S202, the sieved materials including the coal gangue, the carbide slag and the desulfurization gypsum obtained in step S201 are mixed thoroughly in a mixer, followed by adding 2500 g of water and stirring uniformly to obtain a solid-waste-based raw material.

S203, the solid-waste-based raw material is placed in a steel mold and pressed into a test pat, drying the test pat in a blast drying oven at 105° C. for 3 h to obtain a dried test pat, multi-stage calcining is performed on the dried test pat in a high-temperature box furnace followed by cooling to room temperature to obtain a cooled test pat, the cooled test pat is crushed into small pieces, and the small pieces are ground in a grinder followed by sieving through the 50-mesh screen to obtain the solid-waste-based clinker.

In step S203, the multi-stage calcining includes: a first stage from the room temperature to 950° C. with a heating rate of 10° C./min, a second stage from 950° C. to 1290° C. with a heating rate of 5° C./min, and a third stage at 1290° C. for 45 min.

In order to verify the technical effect of the full solid-waste micro-expansive concrete prepared in the disclosure, the following comparative embodiments are set.

### Comparative Embodiment 1

The difference between the comparative embodiment 1 and the embodiment 1 is that adding the modified polyvinyl alcohol and the modified anion exchange resin in the embodiment 1 is changed to the direct addition of polyvinyl alcohol and an anion exchange resin in the comparative embodiment 1. The rest of steps are exactly the same as in the embodiment 1.

### Comparative Embodiment 2

The difference between the comparative embodiment 2 and the embodiment 1 is that the addition of modified polyvinyl alcohol and modified anion exchange resin is directly omitted in the comparative embodiment 2. The rest of steps are exactly the same as in the embodiment 1.

The concrete obtained from the embodiments 1-4 and the comparative embodiments 1-2 is tested for performance in accordance with the standard JGJ/T 70-2009 “standard for test method of performance on building mortar”. After construction and maintenance, the test results are shown in Table 1 below.

TABLE 1
test table of the embodiments 1-4 and the comparative embodiments 1-2.

| | 2 h compressive | 3 d compressive | 7 d compressive | 28 h compressive |
|---|---|---|---|---|
| | strength (MPa) | strength (MPa) | strength (MPa) | strength (MPa) |
| embodiment 1 | 26.1 | 48.6 | 61.2 | 70.9 |
| embodiment 2 | 25.8 | 49.1 | 62.1 | 69.8 |
| embodiment 3 | 25.7 | 47.9 | 60.8 | 71.3 |
| embodiment 4 | 26.4 | 48.3 | 61.9 | 69.2 |
| comparative | 25.6 | 46.1 | 55.9 | 61.1 |
| embodiment 1 | | | | |
| comparative | 25.5 | 45.4 | 52.3 | 57.3 |
| embodiment 2 | | | | |

From the data of embodiment 1 and comparative embodiments 1-2 in Table 1 above, it can be seen that the initial strength of the concrete prepared in the disclosure and the initial strength of the concrete prepared in the comparative embodiments do not differ significantly. However, as time goes on, the subsequent micro-expansion provided by the cementitious material in the concrete prepared in the disclosure leads to an increasing difference in later hardening strength compared to the comparative embodiments. The data of the comparative embodiment 1 and the embodiment 1 show that, since the comparative embodiment 1 only uses the anion exchange resin and the polyvinyl alcohol, it can provide a certain degree of encapsulation for the calcium sulphoaluminate, thereby delaying the hydration of the calcium sulphoaluminate and providing micro-expansion for the later stage of the concrete to compensate for shrinkage. However, compared with the embodiment 1, the anion exchange resin and the polyvinyl alcohol in the comparative embodiment 1 are not modified and cannot slowly release Ca²⁺ and SO₄²⁻. As a result, the strength of the concrete formed in the comparative embodiment 1 is lower than the strength of the concrete in the embodiment 1.

Although the embodiments of the disclosure have been shown and described, it will be understood by those skilled in the art that various changes, modifications, substitutions, and variations can be made to these embodiments without departing from the principles and spirit of the disclosure. The scope of the disclosure is limited by the appended claims and their equivalents.

What is claimed is:

1. A full solid-waste micro-expansive concrete, comprising the following components in parts by weight:
920-1060 parts of a coarse aggregate, 460-582 parts of a fine aggregate, 11-19 parts of an expansive agent, 389-512 parts of a modified solid-waste-based cementitious material, and 231-268 parts of water;
wherein the coarse aggregate is coal gangue; the fine aggregate is waste ceramic; the modified solid-waste-based cementitious material comprises a solid-waste-based clinker, modified polyvinyl alcohol, and a modified anion exchange resin; the solid-waste-based clinker is prepared from the coal gangue, carbide slag, and desulfurization gypsum; and the expansive agent is obtained by calcining the carbide slag;
wherein the modified solid-waste-based cementitious material is prepared through the following steps:
S101, dissolving polyvinyl alcohol in water at 90 degrees Celsius (° C.) to obtain a polyvinyl alcohol solution, adding powder of calcium hydroxide to the polyvinyl alcohol solution, and then stirring and mixing for 8-12 hours (h), followed by drying at a low temperature for solvent removement to obtain the modified polyvinyl alcohol;
S102, washing an anion exchange resin with acid and alkali sequentially to obtain a washed anion exchange resin, placing the washed anion exchange resin into an exchange column, and performing exchange with a sulfate solution, followed by washing with water and drying to obtain the modified anion exchange resin;
S103, mixing the solid-waste-based clinker with the modified anion exchange resin uniformly, and then grinding the solid-waste-based clinker and the modified anion exchange resin followed by sieving through a 200-mesh screen to obtain a mixture; and
S104, dissolving the modified polyvinyl alcohol obtained in step S101 in a mixed solvent of petroleum ether and toluene to obtain a mixed solution, and adding the mixture obtained in step S103 to the mixed solution, followed by stirring for 3-5 h and drying at a low temperature to remove the petroleum ether and the toluene to obtain the modified solid-waste-based cementitious material;
wherein in step S101, a weight ratio of the calcium hydroxide to the polyvinyl alcohol to the water is in a range of 1:(5-8):(22-36);
wherein in step S102, the acid is a hydrochloric acid solution, time for washing the anion exchange resin with the acid is in a range of 2-4 h, a concentration of the hydrochloric acid solution is 3 moles per liter (mol/L), and a weight ratio of the hydrochloric acid solution to the anion exchange resin is 5:1; the alkali is a sodium hydroxide solution, time for washing the anion exchange resin with the alkali is in a range of 1-4 h, a concentration of the sodium hydroxide solution is 2 mol/L, and a weight ratio of the sodium hydroxide solution to the anion exchange resin is 5:1; and the sulfate solution is a sodium sulfate solution, a concentration of the sodium sulfate solution is 0.4 mol/L, and a weight ratio of the sodium sulfate solution to the anion exchange resin is 1:4; and
wherein in step S104, a weight ratio of the petroleum ether to the toluene is 1:1, and a weight ratio of the modified anion exchange resin to the modified polyvinyl alcohol to the solid-waste-based clinker to the petroleum ether is in a range of 1:(0.8-1.8):(8-20):(45-60).

2. The full solid-waste micro-expansive concrete as claimed in claim 1, wherein the solid-waste-based clinker is prepared through the following steps:
S201, washing and air-drying the coal gangue, the carbide slag and the desulfurization gypsum to obtain dried materials, crushing the dried materials in a crusher to obtain crushed materials, grinding the crushed materials in a ball mill to obtain ground materials, and placing the ground materials in an oven for drying at 105° C. until constant weight followed by sieving through a 50-mesh screen to obtain sieved materials;
S202, mixing thoroughly the sieved materials obtained in step S201 in a weight ratio of the coal gangue to the carbide slag to the desulfurization gypsum being 3:5:2 in a mixer, followed by adding water and stirring uniformly to obtain a solid-waste-based raw material; and
S203, pressing the solid-waste-based raw material in a steel mold into a test pat, drying the test pat in a blast drying oven at 105° C. for 3 h to obtain a dried test pat, performing multi-stage calcining on the dried test pat in a high-temperature box furnace followed by cooling to room temperature to obtain a cooled test pat, crushing the cooled test pat into small pieces, and grinding the small pieces in a grinder followed by sieving through the 50-mesh screen to obtain the solid-waste-based clinker.

3. The full solid-waste micro-expansive concrete as claimed in claim 2, wherein in step S202, a weight ratio of the water to a total of the coal gangue, the carbide slag and the desulfurization gypsum in the modified solid-waste-based cementitious material is 1:2.5.

4. The full solid-waste micro-expansive concrete as claimed in claim 2, wherein in step S203, the multi-stage calcining comprises:
a first stage from the room temperature to 950° C. with a heating rate of 10° C. per minute (° C./min), a second stage from 950° C. to 1290° C. with a heating rate of 5° C./min, and a third stage at 1290° C. for 45 min.

5. The full solid-waste micro-expansive concrete as claimed in claim 1, wherein the expansive agent is obtained by calcining the carbide slag at 900° C.

6. A preparation method of the full solid-waste micro-expansive concrete as claimed in claim 1, comprising the following steps:
S1, washing and air-drying the coarse aggregate to obtain a dried coarse aggregate, and crushing the dried coarse aggregate in a crusher followed by sieving to obtain a sieved coarse aggregate with a particle size in a range of 5-20 millimeters (mm);
S2, washing and air-drying the fine aggregate to obtain a dried fine aggregate, crushing the dried fine aggregate in a crusher to obtain a crushed fine aggregate, grinding the crushed fine aggregate in a grinder followed by sieving to obtain a sieved fine aggregate with a particle size in a range of 1-5 mm; and
S3, mixing and stirring uniformly the sieved coarse aggregate, the sieved fine aggregate, the modified solid-waste-based cementitious material, and the water to obtain the full solid-waste micro-expansive concrete.
